(19) United States
(12) Patent Application Publication
(10) Pub. No.: US 2024/0051241 A1
(43) Pub. Date: Feb. 15, 2024

(54) LAYING HEAD FOR A THREAD WINDING UNIT

(71) Applicant: COMMISSARIAT À L'ENERGIE ATOMIQUE ET AUX ENERGIES ALTERNATIVES, PARIS (FR)

(72) Inventors: Christophe MAGNIER, MONTS (FR); Stéphane VILLALONGA, MONTS (FR)

(73) Assignee: COMMISSARIAT À L'ENERGIE ATOMIQUE ET AUX ENERGIES ALTERNATIVES, PARIS (FR)

(21) Appl. No.: 18/259,123

(22) PCT Filed: Dec. 24, 2021
(86) PCT No.: PCT/FR2021/052457

§ 371 Date: Jun. 23, 2023

(30) Foreign Application Priority Data
Dec. 24, 2020 (FR) 2014064

(51) Int. Cl. B29C 70/32; B29C 70/38; B29C 70/16

(52) U.S. Cl. CPC B29C 70/32; B29C 70/384; B29C 70/16

(57) ABSTRACT

A depositing head for a plurality of rovings each coming from a bobbin and having a longitudinal axis, the depositing head including a plurality of line roller pairs for rolling the rovings from the bobbins, each roller pair being intended to be associated, in operation, with only a given single roving and including an upstream roller and a downstream roller relative to the direction of unwinding of the rovings, the rollers rotating independently of one another.

### TECHNICAL FIELD

The present document relates to a laying head for a unit for winding at least one strand from a fiber bobbin. Said bobbin may include one to several fiber(s). These fibers are assembled so as to form a strand deposited around an object such as a hollow mandrel intended to form a reservoir which can, for example, receive a pressurized fluid, such as in particular hydrogen gas. It also relates to a thread winding unit.

### PRIOR ART

Thread winding is a method for implementing by molding composite materials in the form of parts having an axis of revolution (cylinder, cone, etc.). This method is suitable for mass production and is mainly used to manufacture parts subjected to high mechanical stresses (tanks, pipes, etc.).

FIG. 1 represents a thread winding unit 10, according to the known technique, comprising a mandrel 12 rotatably mounted on a frame 14 and around a substantially horizontal longitudinal axis A. The unit 10 comprises a dispenser 16 movable in translation along the longitudinal axis A and supporting a plurality of bobbins 17 extending substantially perpendicularly to a panel of the dispenser and substantially horizontally. Each bobbin 17 comprises a strand 20, which are brought together next to each other at a laying head 22 so as to form a sheet. The laying head 22 is secured to the dispenser 16 via a carriage 24 movable in translation along the longitudinal axis A.

In some configurations (not represented), the laying head can also move in a direction transverse to the axis of the mandrel, turn around said transverse axis, pivot around the longitudinal axis, and possibly move on the vertical axis.

Prior to starting up the thread winding unit, the sheet is attached to the mandrel. Tensioners of the dispenser are activated to tension the fibers, limit shrinkage and compact the deposited successive layers as well as possible. A layer is defined by a winding allowing depositing the sheet over the entire surface of the mandrel that one wishes to cover. It is possible to create a helical type layer with the sheet that is deposited by forming helices in order to cover the entire surface of the cylinder and the desired areas in the hemispherical bottoms. It is possible to make a circumferential type layer where the sheet is deposited almost transversely to the axis of the mandrel over all or over a portion of the cylindrical area of the mandrel.

Structuring by thread winding allows stacking a succession of helical and/or circumferential layers in order to achieve the desired mechanical performances of the object. In general, the machine is controlled by a numerical control. This numerical control is often programmed by an operator using software dedicated to thread winding.

Contact laying machines are known which enable laying of tapes with a short length without any risk of spinning. However, these machines do not allow laying and maintaining a long continuous fiber under tension or axial mechanical stress in the direction of the fiber which is imposed and regulated.

Known processes of this type are ATL standing for Automated Tape Layer and AFP standing for Automated Fiber Placement.

The ATL process uses very wide tapes (generally from 100 to 300 mm). This technique enables deposition over surfaces with a small radius of curvature and large dimensions such as the wing of a civil aircraft. The AFP process carries out a juxtaposition of tape less than 10 mm wide and an assembly at the head outlet of up to 32 tapes.

The main applications are making of planar parts or parts with a large radius of curvature. The main idea is to replace the human hand for laying down successive plies with defined fiber orientations.

All current systems use calibrated pre-impregnated tapes (fiber/resin) with a separation film between the layers on the storage bobbin. These calibrated tapes are derived from unidirectional pre-impregnated sheets recut with the risk of partial cutting of the reinforcement on the edges. The material costs are herein high and it is necessary to have a system for winding the separation film during the draping operations.

None of these systems uses standard pre-impregnated fibers, i.e. with no separation film between the layers for implementation by thread winding. It is not possible to apply a continuous tension (or stress) in tension (in the direction of the fiber) on the strands since the strand(s) making up the sheet are cut at each end of the made part.

To date, the successive developments in the field of implementation of composite materials have for a large part been concentrated on the automation of processes. These developments are driven by the huge needs expressed in the automotive and aeronautics sectors. The development of hydrogen storage technologies (for example at 700 bar operating pressure) with the increase in gravimetric capacity (i.e. the ratio between the amount of stored hydrogen and the mass of the container), pushes composite materials to the limits of use.

Conventional thread winding processes (dedicated machines) and more robotic ones (versatile machines) have never taken into account the full impact of the process in the loss of performance. In most cases, the bobbin support is far away from the laying head and the strands pass through a large number of deflections and rollers before reaching the laying head. Each change in the direction and/or rotation causes by friction with the walls of the roller, the possibility of spinning or folding of the strand on itself. This spinning (twist) is a major source of loss of performance of the material due to the deterioration and/or premature breakage of certain threads that make up a strand. In addition, the modification of the geometry is conducive when stratifying several layers to the appearance of porosities or local excesses of matrix and/or reinforcing fiber.

There are many types of laying heads with different geometries, made of different materials. In general, an industrialist makes a trade-off that allows placing the largest amount of material per hour to the detriment of the quality of the laid material. The laying head is a major component in laying up the composite over the mandrel. The impact on the overall performance of the produced object depends on the quality of laying.

In this respect, the head as described before with reference to FIG. 1 usually comprises a release roller which ensures bringing of the different strands, each originating from a bobbin, together. This roller is made in one-piece and poses the problem of the distance covered by each strand. During laying, each strand covers a unique and specific distance with respect to the theoretical winding axis (immaterial line that defines the most ideal winding trajectory according to the angle and geometry of the object). In other words, each strand covers a distance that is different from the distances covered by the other strands of the other bobbins.

In thread winding units, the laying head, such as that one described for example with reference to FIG. 1, should ensure the following functions:
The indexing of the sheet, i.e. the juxtaposition of the different strands,
The guidance of the formed sheet,
The orientation of the sheet according to the selected angle,
The continuity of tensioning of the strand while minimizing frictions,
The maintenance of the geometry of each strand and therefore of the formed sheet.
   In most embodiments, the head is formed by machined rotating rollers, single or multi-groove, either in plastic materials (fluorinated or not) or metallic (steel, stainless steel, alloy). Each one-piece roller receives several strands.

Yet, it has been noticed that the presence of a one-piece roller could lead to the formation of undulations in the sheet over the mandrel, these undulations creating significant defects in the coating of carbon fibers, which could considerably reduce the expected/desired mechanical strength of the final part. It should be understood that these undulations of the sheet or of the strands on the wound part are one of the signs of a loose laying or else or with a loss of tension at the level of the sheet. After compaction, these undulations result in major defects such as folds of material or heterogeneous areas where the fiber/matrix ratio might be considerably modified.

This problem could arise both when using so-called dry strands, i.e. it is necessary to impregnate during unwinding, or strands impregnated with a partially polymerized matrix called prepregs. In the latter case, each strand has a certain level of stickiness (enabling fastening of the folds to one another over the mandrel) which considerably limits and makes it impossible for the strands to slip. It is noticed that the undulations are even greater with a one-piece roller at the outlet of the laying head.

Moreover, it should be noted that the use of guide rollers for several strands of different bobbins does not allow addressing the aforementioned problem of different distance covered by each strand, which in combination with a one-piece outlet roller further aggravates this problem.

Contact laying machines are the only ones to provide a partial response to this technical problem. They can only use a calibrated sheet (of a higher price). The tensioning level is zero or very low (in contrast with the thread winding technique) because the application by contact does not enable prestressing (tensioning) of the material.

### SUMMARY

The present document relates to a head for laying a plurality of strands each originating from a bobbin and having a longitudinal axis, the laying head comprising a plurality of pairs of line rollers for rolling the strands from the bobbins, each pair of line rollers being intended to be associated in operation with only one given strand and each pair of rollers comprising an upstream roller and a downstream roller with respect to the direction of unwinding of the strands, the line rollers being independent of each other in rotation.

According to the present document, the rotational decoupling of each roller allows guaranteeing a perfect movement of each strand without the latter being subjected to the movements of the other strands. In other words, each strand is thus moved independently of the other strands up to the downstream end of the head for laying over a mandrel.

The rollers may have axes of rotation substantially perpendicular to the direction of the strands.

Each pair of line rollers may be associated with a release roller, said release rollers being coaxial and rotatable independently of each other. Thus, two upstream and downstream rollers are associated with a given release roller which is different from the release rollers associated with the other pairs of upstream and downstream rollers.

Thus, it is possible to avoid the formation of undulations of the sheet over the mandrel, allowing guaranteeing optimum efficiency when laying the sheet over the mandrel.

The axes of rotation of the rollers may be perpendicular to the longitudinal axis.

The upstream roller and the downstream roller of a pair of line rollers may be arranged staggered with respect to the upstream and downstream rollers of another pair of rollers in a plane perpendicular to the axes of rotation of the rollers and containing the longitudinal axis. The upstream roller and the downstream roller of a pair of line rollers may be arranged staggered with respect to the upstream and downstream rollers of another pair of rollers in a plane parallel to the axes of rotation of the rollers. This parallel plane may contain the longitudinal axis.

This double staggered arrangement allows making a maximum number of strands pass in a reduced space.

The k upstream rollers of the k pairs of rollers may be arranged successively along a direction perpendicular to the longitudinal direction and so that the odd upstream rollers are carried by a first upstream pivot and the even upstream rollers are carried by a second pivot arranged downstream of the first pivot.

The k downstream rollers of the k pairs of rollers may be arranged successively along a direction perpendicular to the longitudinal direction L and so that the odd downstream rollers are carried by a third upstream pivot and the even downstream rollers are carried by a fourth pivot arranged downstream of the third pivot. Moreover, the third pivot may be arranged downstream of the second pivot.

At least two upstream rollers of two pairs of rollers may be arranged coaxially in rotation on the same upstream pivot.

At least two downstream rollers of two pairs of rollers may be arranged coaxially in rotation on the same pivot.

Each roller may comprise an annular groove for receiving a strand, this annular groove having a concave bottom surface. The bottom of the annular groove may have a variable radius of curvature, in particular with a radius of curvature which increases from the center of the annular groove towards the outside of the annular groove.

The axis of the downstream roller of each pair of rollers may be located off the plane containing the axis of rotation of the upstream roller and the axis of rotation of the release roller.

The longitudinal axis of the laying head may be positioned so that there is a plane such that all axes of rotation of the rollers are arranged on the same side of said plane.

A strand of a bobbin may be associated with each pair of rollers, the reinforcing fibers, preferably made of carbon fibers, of each strand being impregnated with a curable matrix which may in particular be made of a thermosetting material or a thermoplastic material.

The present document also relates to a device for laying a plurality of strands each originating from a bobbin, comprising a laying head as described before, said laying head being movable in rotation around the longitudinal axis.

The present document also relates to a unit for winding at least one strand consisting of the fiber(s) of at least one bobbin, the unit comprising a device as described hereinabove or a laying head described before and a robot for moving an object intended to be entirely or partially covered by said at least one strand of the bobbin.

### BRIEF DESCRIPTION OF THE DRAWINGS

Other features, details and advantages will appear upon reading the detailed description hereinafter, and upon analyzing the appended drawings, wherein:

FIG. 1, already described before, is a schematic perspective view of a thread winding unit according to the prior art;

FIG. 2 is a schematic perspective view of a laying head according to the present document;

FIG. 3 is a top view of a laying head according to the present document;

FIG. 4 is a side view of a laying head according to the present document;

FIG. 5 is a schematic sectional view of a roller intended to be used with a laying head according to the present document;

FIG. 6 is a schematic view of four downstream rollers of a laying head according to the present document.

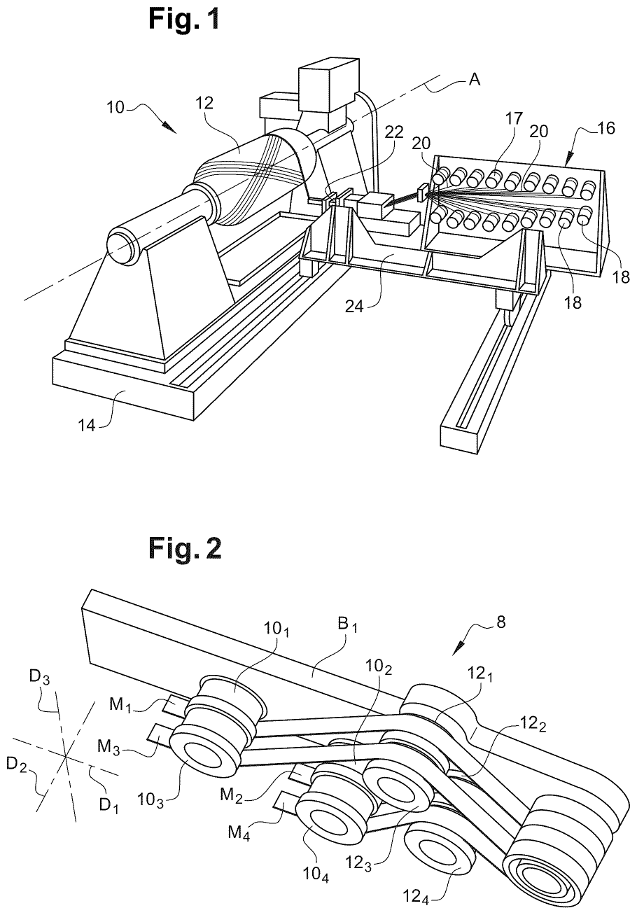

### DESCRIPTION OF THE EMBODIMENTS

Reference is now made to FIGS. 2 to 4 which illustrate a laying head 8 with a longitudinal axis L extending according to a first longitudinal direction D1 according to the present document and which comprises two lateral arms B1, B2 spaced apart from one another according to a second direction D2 perpendicular to the longitudinal direction D1. This second direction D2 is perpendicular to a third direction D3 also perpendicular to the first direction D1. The laying head could comprise one single lateral arm B1 or B2.

Pairs of upstream 10ₖ and downstream 12ₖ rollers are arranged between the lateral arms B₁, B₂ and are independent of each other in rotation, i.e. in pairs. In the example represented in the figures, the laying head comprises four upstream rollers 10₁, 10₂, 10₃, 10₄, and four downstream rollers 12₁, 12₂, 12₃, 12₄. Each of the upstream 10ₖ and downstream 12ₖ rollers comprises an axis of rotation extending according to the second direction D2, the axes of the rollers are therefore perpendicular to the longitudinal direction D1 and to the longitudinal axis L of the laying head 8. The upstream 10ₖ and downstream 12ₖ rollers are so-called line rollers since they achieve guidance along a line of a strand Mₖ., this line is parallel to the longitudinal axis L. It would still be possible to qualify them as rollers guiding a strand. In the example represented in the figures, one could note the presence of four strands M₁, M₂, M₃, M₄ each associated with a pair of upstream 10ₖ and downstream 12ₖ rollers. It should be understood that the present disclosure covers all configurations where the number k of pairs of rollers [10ₖ, 12ₖ] is greater than or equal to 2. It should be obviously understood that the invention is more particularly interesting when the number of pairs of rollers is large and for example greater than or equal to four.

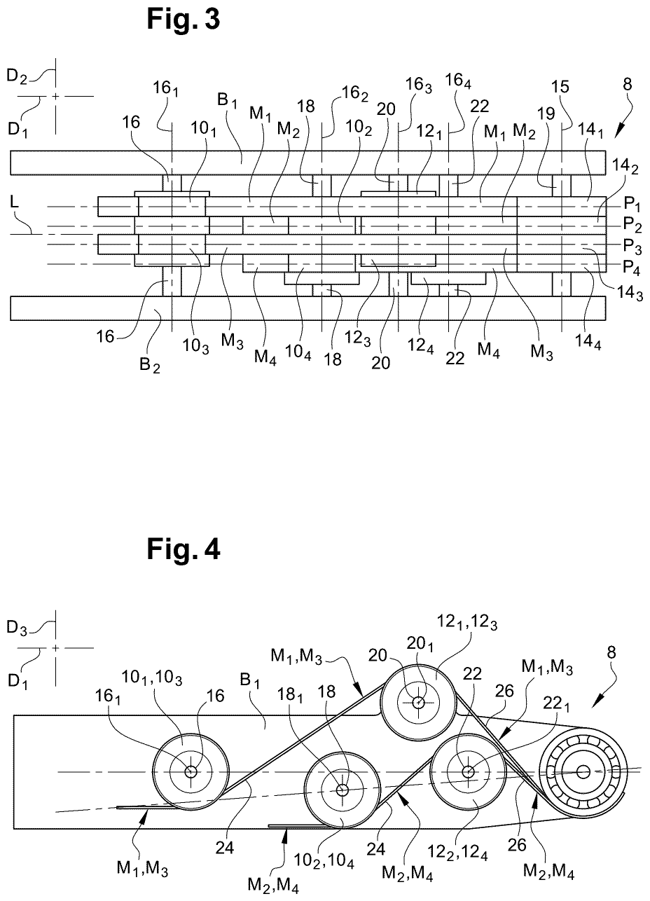

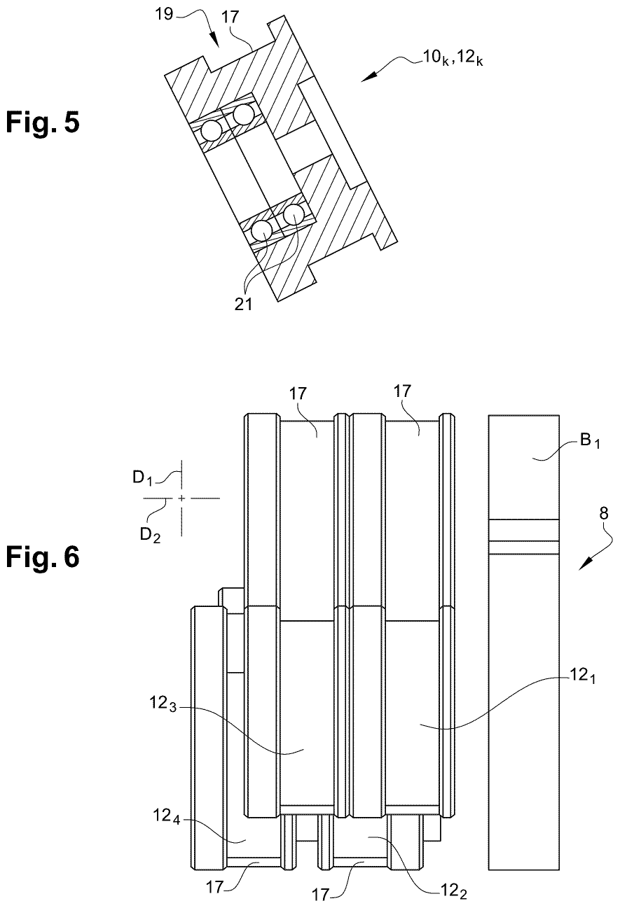

As shown in FIG. 3, each upstream roller is associated with a downstream roller so as to form a pair of line rollers guiding a given strand, the other strands being guided by distinct pairs of line roller pairs.

It should be understood that the terms “upstream” and “downstream” refer to rollers positioned with respect to each other upstream or downstream with respect to the direction of unwinding or laying of the strands M₁, M₂, M₃, M₄, i.e. with respect to the unwinding direction of the strand. In this case, the direction of unwinding of the strand M₁, M₂, M₃, M₄ is oriented from left to right along the first direction D1.

Each pair of upstream 10ₖ and downstream 12ₖ line rollers is associated with a release roller 14ₖ. The release rollers are coaxial with the axis 15. They are herein mounted on the same pivot 19. In the example of the laying head 8 represented in the figures, there are four release rollers 10₁, 10₂, 10₃, 10₄. Each pair of upstream and downstream rollers comprises a face for supporting the strand Mₖ which is symmetrical with respect to a plane Pₖ containing the first longitudinal direction D1 and the third longitudinal direction D3. The release roller associated with the pair of line rollers 10ₖ, 12ₖ comprises a surface for supporting the strand Mₖ which is also symmetrical with respect to the plane Pₖ. It should be understood that the aforementioned support faces are annular faces and with a circular section but that the supports are not annular.

The support faces 17 of the upstream 10ₖ and downstream 12ₖ line rollers are formed at the bottom of an annular groove 19. These bearing faces 17 may have a section with a concave curved shape, although represented as being substantially planar. These bottom faces 17 of the annular groove 19 may have a variable radius of curvature, in particular with a radius of curvature which increases from the center of the annular groove outwards the annular groove 19. Each upstream 10k and downstream 12ₖ line roller may comprise two ball bearings 21 to ensure a perfectly centered rotational movement.

In the arrangement of the present description, the k rollers are arranged successively along the direction D2. The rollers 10ₖ where k is odd are carried by the same pivot 16 and the rollers 10k where k is even are carried by the same other pivot 18. The pivot 16 is arranged upstream of the pivot 18. The rollers 12k where k is odd are carried by the same pivot 20 and the rollers 12k where k is even are carried by the same other pivot 22. The pivot 20 is arranged upstream of the pivot 22. The pivot 18 is arranged upstream of the pivot 20. The pivots 16, 18, 20, 22 are arranged upstream of the pivot 19 of the release rollers 14ₖ. The pivots 16, 18, 20, 22 extend according to the second direction D2 and therefore extend perpendicular to the longitudinal axis L. One could observe that the pivots 16, 18, 20, 22 are arranged staggered along a plane perpendicular to the axes 16₁, 16₂, 16₃, 16₄ of the pivots 16, 18, 20, 22 and containing the longitudinal axis L (FIG. 4). Similarly, one could observe a staggered arrangement of the upstream and downstream even line rollers with the upstream and downstream odd line rollers, in a plane parallel to the axes of the line rollers or axes of rotation of the rollers 10ₖ, 12ₖ.

The k upstream rollers may be arranged successively along a direction D2 perpendicular to the longitudinal direction L and so that the odd upstream rollers are carried by a first upstream pivot 16 and the even upstream rollers are carried by a second pivot 18 arranged downstream of the first pivot 16.

The k downstream rollers may be arranged successively along a direction D2 perpendicular to the longitudinal direction L and so that the odd downstream rollers are carried by a third upstream pivot 20 and the even downstream rollers are carried by a fourth pivot 22 arranged downstream of the third pivot 20. Moreover, the third pivot 20 may be arranged downstream of the second pivot 18.

In FIG. 4, one could observe that the axis 20₁, 22₁ of the downstream roller 12₁, 12₂, 12₃, 12₄ of each pair of rollers is located off the plane containing the axis of rotation of the associated upstream roller 10₁, 10₂, 10₃, 10₄ and the axis of rotation 15 of the release roller 14ₖ. Moreover, one could observe that the portion 24 of a strand Mₖ located between an upstream roller and a downstream roller forms with the portion 26 of a strand Mₖ located between the downstream roller and the release roller an angle substantially equal to 90°. This angle may be comprised between 70 and 110°, preferably between 80 and 100°.

In FIG. 3, one could observe that a strand Mₖ is guided, in the unwinding direction, by an upstream line roller 10ₖ, a downstream line roller 12ₖ and a release roller 14ₖ and along a line Pₖ. In the practical case, one could observe the presence of 4 lines, Pₖ, P₂, P₃, P₄.

The upstream line rollers comprise a first series of upstream rollers 10ₖ where k is odd and which are carried by the same pivot 16 and a second series of upstream rollers 10ₖ where k is even and which are carried by the same pivot 18. The downstream line rollers comprise a first series of downstream rollers 12ₖ where k is odd and which are carried by the same pivot 20 and a second series of downstream rollers 12ₖ where k is even and which are carried by the same pivot 22. The pivots 16, 18, 20, 22 are distinct in pairs. According to the longitudinal direction L and along the unwinding direction, one could observe that the pivots are arranged from upstream to downstream so as to have the pivot 16 of the first series of upstream rollers 10ₖ where k is odd, the pivot 18 of the second series of upstream rollers 10ₖ where k is even, the pivot 20 of the first series of downstream rollers 12ₖ where k is odd, then the pivot 22 of the second series of downstream rollers 12ₖ where k is even. A strand Mₖ cooperates with an upstream roller of a series of upstream rollers and a downstream roller of a series of downstream rollers. More particularly, a strand Mₖ with k being an odd number cooperates with an upstream roller of the first series of upstream rollers and a downstream roller of a first series of downstream rollers and a strand Mₖ with k being an even number cooperates with an upstream roller of the second series of upstream rollers and a downstream roller of a second series of downstream rollers. The arrangement of the rollers is such that the strands Mₖ with k being an even number and the strands Mₖ with k being an odd number are arranged alternately along the second direction D2.

1-13. (canceled)

14. A head for laying a plurality of strands each originating from a bobbin and having a longitudinal axis, the laying head comprising a plurality of pairs of line rollers for rolling the strands from the bobbins, each pair of line rollers being intended to be associated in operation with only one given strand and comprising an upstream roller and a downstream roller with respect to the direction of unwinding of the strands, the line rollers being independent of each other in rotation.

15. The laying head according to claim 14, wherein each pair of line rollers is associated with a release roller, said release rollers being coaxial and rotatable independently of each other.

16. The laying head according to claim 14, wherein the axes of rotation of the rollers are perpendicular to the longitudinal axis.

17. The laying head according to claim 16, wherein the upstream roller and the downstream roller of a pair of line rollers are arranged staggered with respect to the upstream and downstream rollers of another pair of rollers in a plane perpendicular to the axes of rotation of the rollers and containing the longitudinal axis.

18. The laying head according to claim 14, wherein the upstream roller and the downstream roller of a pair of line rollers are arranged staggered with respect to the upstream and downstream rollers of another pair of rollers in a plane parallel to the axes of rotation of the rollers.

19. The laying head according to claim 14, wherein at least two upstream rollers of two pairs of rollers are arranged coaxially in rotation on the same upstream pivot.

20. The laying head according to claim 14, wherein at least two downstream rollers of two pairs of rollers are arranged coaxially in rotation on the same pivot.

21. The laying head according to claim 14, wherein each roller comprises an annular groove for receiving a strand, this annular groove having a concave curved bottom surface.

22. The laying head according to claim 14, wherein the axis of the downstream roller of each pair of rollers is located off the plane containing the axis of rotation of the upstream roller and the axis of rotation of the release roller.

23. The laying head according to claim 14, wherein the longitudinal axis of the laying head is positioned so that there is a plane such that all axes of rotation of the rollers are arranged on the same side of said plane.

24. The laying head according to claim 14, wherein a strand of a bobbin is associated with each pair of rollers, the reinforcing fibers, preferably made of carbon fiber, of each strand being impregnated with a curable matrix.

25. A device for laying a plurality of strands each originating from a bobbin, comprising a laying head according to claim 14, said laying head being movable in rotation around the longitudinal axis.

26. A unit for winding at least one strand from a bobbin, the unit comprising a device according to the preceding claim or a laying head according to claim 14 and a robot for moving an object intended to be entirely or partially covered by said at least one strand of the bobbin.
